(19) United States
(12) Patent Application Publication
(10) Pub. No.: US 2004/0179844 A1
(43) Pub. Date: Sep. 16, 2004

(54) Wavelength-division-multiplexed metro optical network

(75) Inventors: Yun Chur Chung, Daejeon (KR); Hwan Seok Chung, Gyeongsangbuk-do (KR)

Correspondence Address: OLIFF & BERRIDGE, PLC, P.O. BOX 19928, ALEXANDRIA, VA, 22320, US

(73) Assignee: KOREA ADVANCED INSTITUTE OF SCIENCE AND TECHNOLOGY, DAEJEON (KR)

(21) Appl. No.: 10/693,486

(22) Filed: Oct. 27, 2003

(30) Foreign Application Priority Data
Mar. 12, 2003 (KR) 2003-15389

(51) Int. Cl. H04J 14/02

(52) U.S. Cl. 398/82

(57) ABSTRACT

Disclosed herein is a wavelength-division-multiplexed metro optical network. The network comprises a transmitting unit having direct modulating transmitters and a multiplexer for multiplexing the optical signals and transmitting the multiplexed signal, and a receiving unit having a demultiplexer for receiving the multiplexed signal from the multiplexer, demultiplexing the received signal and outputting the demutiplexed signals, and receivers for receiving the demutiplexed signals. The network further comprises an optical fiber connected between the multiplexer and the demultiplexer. The optical fiber has a negative dispersion value of from −1 ps/nm/km to −3.3 ps/nm/km at a wavelength of 1550 nm, and a positive dispersion inclination. The network adopts a direct modulation system and uses the optical fiber, which has an appropriately adjusted negative dispersion value, thereby decreasing distortion of an optical signal, preventing an error, performing a long-distance transmission of the signal over 300 km without performance deterioration due to four-wave mixing.

### BACKGROUND OF THE INVENTION

1. Field of the Invention

The present invention relates to a wavelength-division-multiplexed (hereinafter, referred to as “WDM”) metro optical network, and more particularly to a WDM metro optical network using a negative dispersion optical fiber and adopting a direct modulation system.

2. Description of the Related Art

The recent rapid enlargement of various data services including the Internet has required that transmission capacities of transmission networks be steeply increased. Such a requirement may be economically achieved by the provision of a WDM optical transmission system for multiplexing several optical signals with different wavelengths and transmitting the multiplexed optical signal on a single optical fiber. At present, such a WDM optical transmission system is widely used to increase transmission capacities of long-haul networks. Also, the WDM optical transmission system is widely used in metro networks, such as local networks or regional networks.

What is to be considered first of all in realizing the metro networks is economical efficiency. For this reason, it is of the highest importance to choose cost-effective transmitters and the modulation scheme of the optical signals.

FIG. 1 is a graph showing dispersion values on the basis of wavelengths of exemplary optical fibers used in conventional optical networks.

As shown in FIG. 1, the exemplary optical fibers used in the conventional optical networks include: a conventional single-mode fiber (hereinafter, referred to as SMF) having a dispersion value of approximately 16 ps/nm/km at a wavelength of 1550 nm; a non-zero dispersion-shifted fiber (hereinafter, referred to as NZDSF) having a dispersion value of from 1.5 ps/nm/km to 4 ps/nm/km at a wavelength of 1550 nm; and a MetroCor fiber having a dispersion value of approximately −7 ps/nm/km at a wavelength of 1550 nm.

Modulation schemes for converting an electrical signal into an optical signal at a transmitter unit of the optical network are generally classified into an external modulation and a direct modulation. In the external modulation scheme, light outputted from a laser is converted into a digital signal comprising ‘1s’ and ‘0s’ using an additional external modulator. On the other hand, in the direct modulation scheme, a drive current of a laser is changed on the basis of input signals. With the external modulation scheme, there is generated no chirp in the modulated optical signal since an additional modulator is used in the external modulation. Consequently, long-distance transmission is possible using the external modulation scheme. The term “chirp” means a phenomenon that the wavelength of the optical signal is instantaneously changed on the basis of the inputted electrical digital signal. However, the modulator used in the external modulation system needs a high drive voltage, which requires the provision of an additional high-voltage electric signal amplifier. Consequently, the cost of manufacturing the external modulation system is high. On the other hand, the direct modulation system has advantages in that no additional modulator is required, and thus the cost of manufacturing the direct modulation system is relatively low. Also, the direct modulation system is capable of securing high output optical power with its simple structure. With the aforesaid direct modulation system, however, the frequency of the optical signal is changed on the basis of changes in carrier density inside the laser. As a result, there is generated chirp in which the leading edge of a pulse in time domain has a short wavelength component (blue shift) and the falling edge of the pulse in time domain has a long wavelength component (red shift) while the optical signal passes through the optical fiber. Consequently, the spectral width of signal is widened, and thus the pulse is distorted when the signal is transmitted through optical fiber.

Some of the conventional exemplary optical fibers, for example, the SMF and the NZDSF, have positive dispersion values, respectively. Consequently, each of the aforesaid optical fibers has a pulse in which the leading edge thereof is blue shifted and the falling edge thereof is red shifted as in the chirp generated when the optical signal of the laser is directly modulated. For this reason, pulse spread is accelerated, and thus the transmission distance is extremely limited, in the case that the direct modulated signal is transmitted using the SMF or the NZDSF. To solve the above-mentioned drawbacks, there have been proposed an optical phase conjugation or mid-span spectral inversion method for converting a phase of the optical signal in the middle of the transmission system to control the pulse spread and a method for eliminating a part of the wavelength components generated by the chirp using an optical filter. However, those methods are very complicated, and decrease an available bandwidth of the optical fiber. Consequently, the performance of the transmission system is not particularly improved even using the above-mentioned methods. Another method for controlling the pulse spread generated in the optical fiber by means of a dispersion compensation fiber (hereinafter, referred to as DCF) is also applicable. However, this method has a drawback in that the cost of constructing the network is increased since the DCF fiber is very expensive and in that an additional optical amplifier is required to compensate for a loss generated in the DCF fiber itself. In order to solve the above-mentioned problems and effectively use the chirp characteristics of the direct modulated optical signal, it is important to control a dispersion value of the optical fiber. Especially, the dispersion value of the optical fiber must be a negative dispersion value with a small absolute value. As shown in FIG. 1, when the directly modulated optical signal is transmitted using the MetroCor fiber having a negative dispersion value, the chirp is generated in the opposite direction, whereby the pulse spread is effectively controlled. However, the dispersion value of the MetroCor fiber is −7 ps/nm/km at a wavelength of 1550 nm, and thus the absolute value of the dispersion value of the MetroCor fiber is excessively large as compared to the chirp generated by the conventional direct modulation. Specifically, when an optical signal having a transmission speed of 10 Gb/s, which is generally used in the metro network, is directly modulated, and the directly modulated optical signal is transmitted on the MetroCor fiber, the maximum transmission distance is limited to not more than 100 km. Consequently, dispersion compensation is required in the case of constructing the metro network using the MetroCor fiber, considering that the size of the metro network is principally from 100 km to 200 km, the maximum transmission distance required for protection or restoration is 300 km or more. However, such dispersion compensation increases complexity of the system and decreases economical efficiency of the system, as mentioned above.

### SUMMARY OF THE INVENTION

Therefore, the present invention has been made in view of the above problems, and it is an object of the present invention to provide an economic wavelength-division-multiplexed metro optical network which uses an optical fiber capable of performing a long-distance transmission over 300 km without dispersion compensation or optical filtering.

In accordance with the present invention, the above and other objects can be accomplished by the provision of a wavelength-division-multiplexed metro optical network comprising: a transmitting unit having transmitters for directly modulating a light into digital optical signals with different wavelengths and outputting the modulated optical signals and a multiplexer for multiplexing the optical signals outputted from the transmitters and transmitting the multiplexed signal; a receiving unit having a demultiplexer for receiving the multiplexed signal outputted from the multiplexer, demultiplexing the received signal on the basis of the respective wavelengths, and outputting the demutiplexed signals, and receivers for receiving the demutiplexed signals outputted from the demultiplexer; and an optical fiber connected between the multiplexer and the demultiplexer, wherein the optical fiber has a negative dispersion value of from −1 ps/nm/km to −3.3 ps/nm/km at a wavelength of 1550 nm, and a positive dispersion inclination.

Preferably, the network further comprises at least one optical amplifier disposed between the multiplexer and the demultiplexer. The distance between an optical amplifier and the neighboring optical amplifier is preferably from 10 km to 80 km.

Preferably, the optical fiber has a zero-dispersion wavelength of from 1560 nm to 1595 nm.

Preferably, the transmitters have a transmission speed per channel of 10 Gb/s.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing dispersion values on the basis of wavelengths of exemplary optical fibers used in conventional optical networks;

FIG. 2 is a schematic block diagram illustrating a wavelength-division-multiplexed (WDM) metro optical network according to a preferred embodiment of the present invention;

FIG. 3 is a schematic block diagram illustrating various formations for testing characteristics of the optical networks using the conventional optical fibers as shown in FIG. 1 and of the optical network according to the preferred embodiment of the present invention;

FIG. 4 includes graphs respectively illustrating a measured eye diagram for each of the optical networks as shown in FIG. 3;

FIG. 5 is a graph illustrating values of Q measured on the basis of transmission distances for the respective optical fibers used in the optical networks as shown in FIG. 3;

FIG. 6 is a graph illustrating maximum transmission distances and corresponding values of dispersion for optical fibers at which values of Q are maintained at 18 dB or more after directly modulated signals are transmitted without compensation for dispersion of positive and negative dispersion optical fibers; and

FIGS. 7a to 7c are graphs illustrating performances of the optical network according to the preferred embodiment of the present invention, which are measured using 16 WDM optical signals multiplexed at a channel interval of 100 GHz.

### DESCRIPTION OF THE PREFERRED EMBODIMENTS

FIG. 2 is a schematic block diagram illustrating a WDM metro optical network according to a preferred embodiment of the present invention.

As shown in FIG. 2, the WDM metro optical network of the present invention comprises a transmitting unit having transmitters and a multiplexer; a receiving unit having a demultiplexer and receivers; an optical fiber connected between the multiplexer and the demultiplexer; and optical amplifiers arranged at a predetermined interval between the multiplexer and the demultiplexer.

Transmitters change a drive current of a laser on the basis of input signals to directly modulate the light into digital optical signals with different wavelengths. The multiplexer serves to receive the optical signals outputted from the transmitters, multiplex the received signals, and transmit the multiplexed signal.

The demultiplexer serves to receive the multiplexed signal outputted from the multiplexer, demultiplex the received signal on the basis of the respective wavelengths, and output the demutiplexed signals. The receivers receive the demutiplexed signals outputted from the demultiplexer, convert the received signals into electric signals, and output the converted signals.

As the optical fiber connected between the multiplexer and the demultiplexer is used a negative dispersion fiber having a zero-dispersion wavelength of from 1560 nm to 1595 nm, a negative dispersion value of from −1 ps/nm/km to −3.3 ps/nm/km at a wavelength of 1550 nm, and a positive dispersion inclination. When the directly modulated signal is transmitted on the conventional optical fibers, each of which has a positive dispersion value, the pulse spread is accelerated. Furthermore, the distortion of the optical signal increases if the absolute value of the dispersion value of the negative dispersion fiber is excessively large. On the other hand, the distortion of the optical signal decreases if the dispersion is too small, i.e., the distortion approaches zero. In this case however, there is induced a four-wave mixing phenomenon (hereinafter, referred to as FWM) in which optical signals with different wavelengths are mixed with each other to generate a new interference signal. For this reason, the aforesaid negative dispersion fiber is preferably used in the present invention.

The optical amplifiers are disposed between the multiplexer and the demultiplexer for compensating for the loss of the optical fiber. Erbium doped fiber amplifiers (EDFA) are preferably used. The erbium doped fiber amplifiers serve to amplify an optical signal having a wavelength component of between 1530 and 1565 nm. Consequently, decrease in intensity of the optical signal due to loss of the optical fiber and thus decrease of the transmission distance are prevented by means of the erbium doped fiber amplifiers in the case of the system transmitting the optical signal within the range of the amplified wavelengths. In this embodiment, the optical amplifiers are disposed at a predetermined interval, for example, in such a manner that the distance between an optical amplifier and the neighboring optical amplifier is from 10 km to 80 km.

If necessary, an optical add/drop module may be disposed between the multiplexer and the demultiplexer.

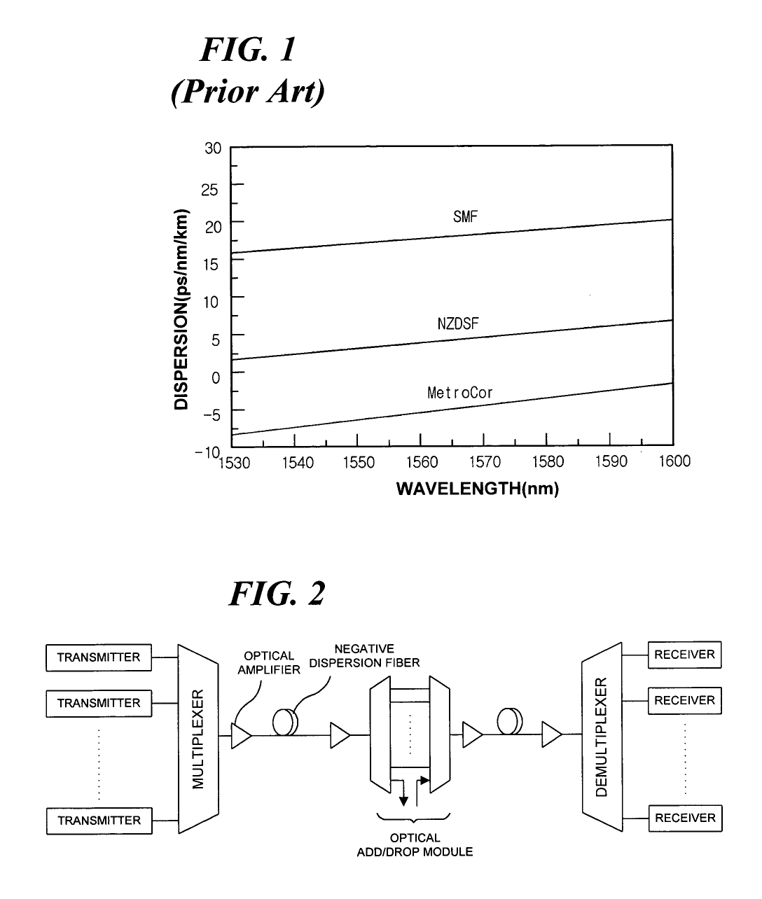

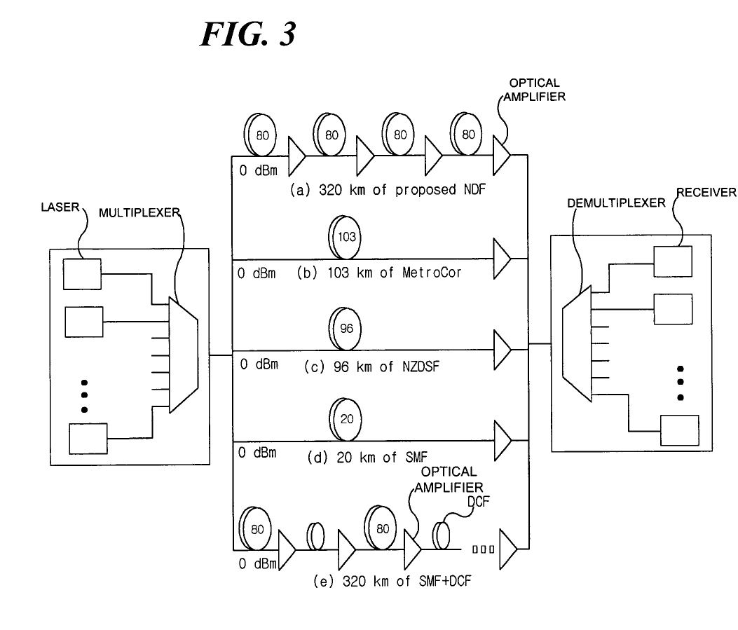

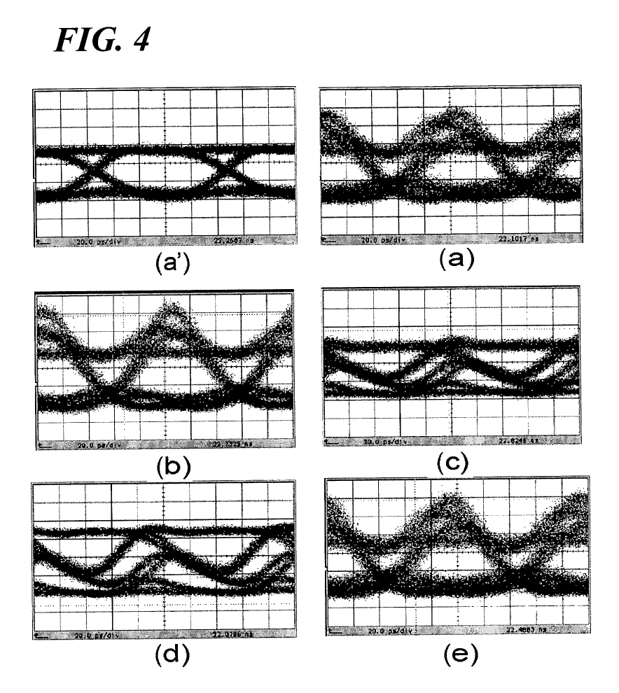

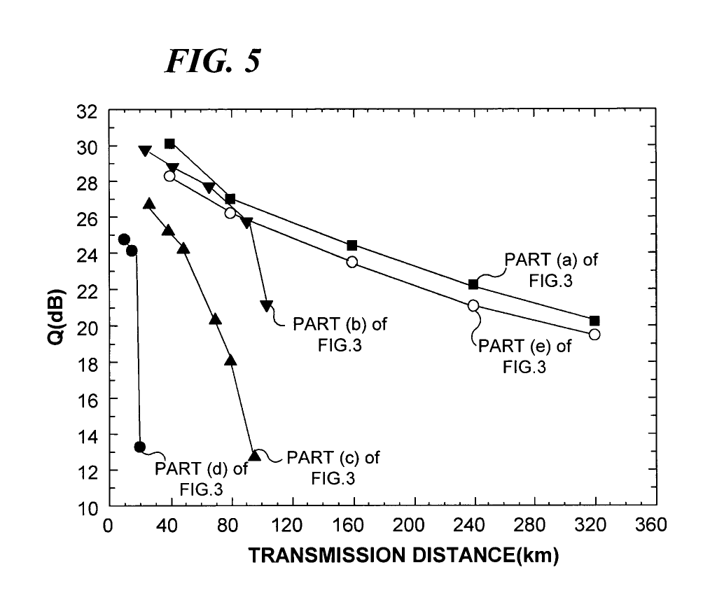

A comparison between the optical network of the present invention and the optical network using the optical fibers as shown in FIG. 1 will now be made with reference to FIG. 3.

FIG. 3 is a schematic block diagram illustrating various formations for testing characteristics of the optical networks using the conventional optical fibers as shown in FIG. 1 and of the optical network according to the preferred embodiment of the present invention. The part (a) of FIG. 3 indicates the optical network of the present invention, in which a negative dispersion fiber having a length of 320 km is used for a transmission line. Optical amplifiers are disposed at an interval of 80 km to amplify the modulated signal. However, dispersion of the optical fiber is not compensated. The part (b) of the FIG. 3 indicates the optical network in which a MetroCor fiber having a length of 103 km is used for a transmission line. The part (c) of the FIG. 3 indicates the optical network in which an NZDSF fiber having a length of 96 km is used for a transmission line. The part (d) of the FIG. 3 indicates the optical network in which a SMF having a length of 20 km is used for a transmission line. The part (e) of the FIG. 3 indicates the optical network in which a SMF having a length of 320 km is used for a transmission line, and DCFs are disposed at an interval of 80 km for compensating for dispersion.

As shown in FIG. 3, a directly modulated laser (hereinafter, referred to as DML) is commonly provided at the transmitting unit for every optical network. The laser is modulated at a transmission speed of 10 Gb/s per channel. Threshold current and wavelength of the DML are 21.5 mA and 1550.12 nm at 25° C., respectively. The optical power of the signal applied to the respective optical fibers is 0 dBm. In the optical network as shown in FIG. 3, only one DML is used, although a plurality of lasers having constant channel spacing may be provided at the transmitting unit.

The loss of the optical fiber used in the optical network of the present invention is not more than 0.2 dB at a wavelength of 1550 nm. The dispersion value and the zero dispersion wavelength of the optical fiber used in the optical network of the present invention are not more than −2.5 ps/nm/km and 1585 nm, respectively. The erbium doped fiber amplifiers (EDFA) are used for the optical amplifier, although an optical add/drop module may be used instead of the erbium doped fiber amplifiers in a real metro network.

Dispersion of each of the DCF fibers as shown in the part (e) of FIG. 3 is approximately −80 ps/nm per 1 km, and the light loss is as large as 0.5 dB or more, which requires additional optical amplifiers to compensate for the signal loss. Consequently, two-stage amplifiers are additionally used.

In the cases of the parts from (a) to (e) of the FIG. 3, arrayed waveguide gratings (hereinafter, referred to as AWG) are used as the receivers for eliminating amplified spontaneous emission noise (ASE noise) generated from the optical amplifiers. The 3 dB bandwidth of the used AWG is 0.32 nm, which is larger than the spectral width of the signal. Consequently, the signal is not filtered.

(a′) to (e) of FIG. 4 are graphs respectively illustrating a measured eye diagram for each of the optical networks as shown in FIG. 3. (a′) of FIG. 4 illustrates the eye diagram measured on the signal outputted from the laser, and (a) to (e) of FIG. 4 illustrate the eye diagrams measured after the optical signals are transmitted using the optical networks as indicated by the parts (a) to (e) of the FIG. 3.

The eye diagram is used as a measure to indicate the degree of distortion of an optical signal. When the degree of eye opening in the eye diagram is maximized, the distortion of the optical signal is decreased.

It can be seen from (a) to (d) of FIG. 4 that the eyes are opened wider in the case of the part (a) an (b) of FIG. 3, i.e., in the case of using the optical signal having the negative dispersion values, respectively, than in the case of the part (c) an (d) of FIG. 3, i.e., in the case of using the optical signal having the positive dispersion values, respectively. It can be also seen that the degree of eye opening in the case of the part (e) of FIG. 3 is higher than the degrees of eye opening for the optical signals having the positive dispersion values, respectively, since the dispersion is compensated using the DCFs although the optical fiber having the positive dispersion value is used.

As described above, there is generated chirp in which the leading edge of the pulse has the short wavelength component (blue shifted) and the falling edge of the pulse has the long wavelength component (red shifted) while the directly modulated optical signal passes through the optical fiber. Consequently, the spectral width of signal is widened, and thus the pulse is distorted when the transmission distance is increased. In the case of using the optical fiber having the negative dispersion value, however, wavelength shifts opposite to the above-mentioned shifts are induced with the result that the pulse is compressed. Consequently, the degree of eye opening is higher in the case of using the optical fiber having the negative dispersion value than in the case of using of the optical fiber having the positive dispersion value.

FIG. 5 is a graph illustrating values of Q measured on the basis of transmission distances for the respective optical fibers used in the optical networks as shown in FIG. 3. The transmission speed per channel is 10 Gb/s.

The Q value indicates the ratio of the optical signal to the noise at the receiving unit. The Q value is used to evaluate the performance of the optical transmission system. Generally, the Q value of the optical transmission system must be maintained at 18 dB (BER<10⁻¹⁵) or more. The higher the Q value, the lower the bit error rate. Finally, few errors are caused.

It can be seen from FIG. 5 that the maximum transmission distance within which the Q value is maintained at 18 dB or more is not more than 20 km in the case of the part (d) of FIG. 3, i.e., in the case of using the SMF for the transmission line, and the maximum transmission distance within which the Q value is maintained at 18 dB or more is not more than 80 km in the case of the part (3) of FIG. 3, i.e., in the case of using the NZDSF for the transmission line. It can be also seen from FIG. 5 that the Q value is 21.1 dB within the transmission distance of 103 km in the case of the part (b) of FIG. 3, i.e., in the case of using the MetroCor fiber for the transmission line. However, the dispersion value of the optical fiber increases when the transmission distance is over 103 km, and thus the Q value abruptly decreases.

In the case of the part (a) of FIG. 3, i.e., in case of the optical network of the present invention, the Q value is 20.2 dB or more without compensation for the dispersion even when the transmission distance is 320 km or more, which reveals that the transmission performance of the optical network as indicated by the part (a) of FIG. 3 is excellent as compared to that of the optical network as indicated by the part (e) of FIG. 3 wherein the SMF is used, and the dispersion is compensated. The reason why the transmission performance of the part (e) of the FIG. 3 is less than that of the part (a) of the FIG. 3 is that additional optical amplifiers are used to compensate for the great amount of optical loss incurred in the DCFs, and thus the optical signal to noise ratio is decreased.

Consequently, it is understood that the dispersion value of the optical fiber must be a negative dispersion value with a small absolute value, as in the optical network of the present invention, in order to effectively utilize the chirp characteristics of the directly modulated laser.

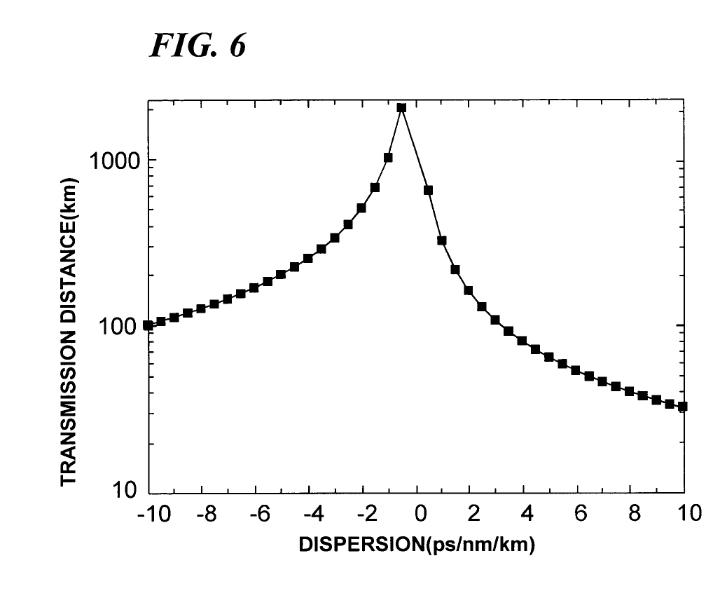

FIG. 6 is a graph illustrating maximum transmission distances and corresponding values of dispersion for optical fibers at which values of Q are maintained at 18 dB or more after directly modulated signals are transmitted without compensation for dispersion of positive and negative dispersion optical fibers. It is assumed that the transmission speed per channel is 10 Gb/s.

In the case of the optical network using the conventional NZDSF, the dispersion value of the NZDSF is +4 ps/nm/km, and the maximum transmission distance in which the Q value is 18 dB is approximately 80 km, as shown in FIGS. 1 and 5. Consequently, the maximum accumulated dispersion value (the product obtained by multiplying the distance in which the Q value is 18 dB and the dispersion value of the optical fiber) is +320 ps/nm. In the case of using the optical network of the present invention, the dispersion value is −2.5 ps/nm/km, and the maximum transmission distance in which the Q value is 18 dB is approximately 400 km. Consequently, the maximum accumulated dispersion value is −1000 ps/nm. In the case that the dispersion is positive, therefore, the dispersion value of the optical fiber must be less than 1.1 ps/nm/km, which is obtained by dividing the maximum cumulative dispersion value of +320 ps/nm by the transmission distance of 300 km, in order to transmit the optical signal without compensation for the dispersion in the case of the direct modulation. In the case that the dispersion is negative, on the other hand, the dispersion value of the optical fiber must be more than −3.3 ps/nm/km, which is obtained by dividing the maximum cumulative dispersion value of −1000 ps/nm by the transmission distance of 300 km, in order to transmit the optical signal without compensation for the dispersion in the case of the direct modulation. In other words, it is understood that the dispersion value of the optical fiber is in the range of −3.3 ps/nm/km to +1.1 ps/nm/km. However, the dispersion value of the optical fiber must be negative in order to use the chirp of the optical fiber. Consequently, the dispersion value of the optical fiber is preferably in the range of −3.3 ps/nm/km to 0 ps/nm/km. Besides, the dispersion value of the optical fiber must be a definite value or more in the WDM optical transmission system wherein several channels are multiplexed and then transmitted so that the FWM is not induced. Consequently, the absolute value of the dispersion value is set to approximately 1 ps/nm/km. As a result, it is understood that the dispersion value of the optical fiber must be in the range of −3.3 ps/nm/km to −1.1 ps/nm/km so that the 10 Gb/s directly modulated signal can be transmitted over a long distance without performance deterioration due to the FWM within a C band (1530 nm −1560 nm) of the commonly used optical amplifier.

Consequently, when the optical fiber having the dispersion value of −2.5 ps/nm/km at the wavelength of 1550 nm and the zero dispersion wavelength of 1585 nm, which is an example of the optical fibers used in the optical network of the present invention, the degree of eye opening is maximized, and thus the distortion of the optical signal is decreased. Furthermore, the Q value is high with the result that the bit error ratio is lowered, whereby the error is prevented. Also, the transmission distance can be increased over 300 km, and the long-distance transmission of the signal is possible without performance deterioration due to the FWM.

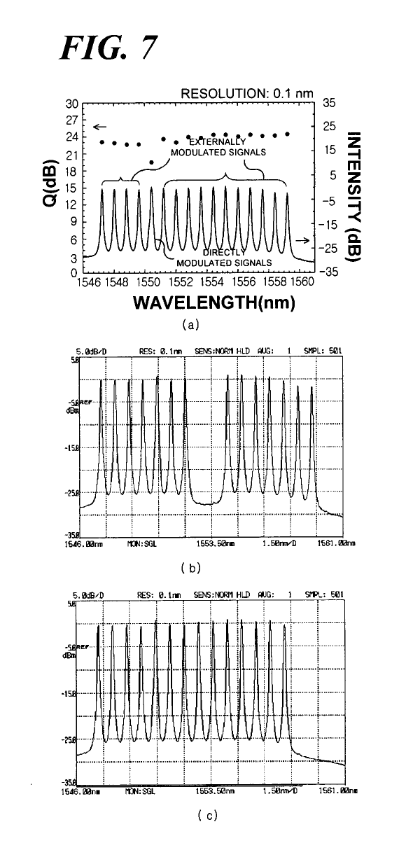

FIGS. 7a to 7c are graphs illustrating performances of the optical network according to the preferred embodiment of the present invention, which are measured using 16 WDM optical signals multiplexed at a channel interval of 100 GHz.

FIG. 7a illustrates Q-values of the optical signals when the 16 WDM optical signals operating at the wavelengths of from 1547.72 nm to 1559.79 nm are transmitted, wherein the optical signal at the fifth channel is directly modulated and the optical signals at the remaining channels are externally modulated using lithium niobate (LiNbO₃) modulators. It should be noted that only the optical signal at the fifth channel is directly modulated since the directly modulated lasers are limited from the experimental properties, although the optical signals at all the channels may be directly modulated.

As can be seen from FIG. 7a, the Q-value of each of the channels is 19.5 dB or more even when the transmission distance is 320 km, and the performance deterioration is negligible as compared to the transmission on a single channel.

FIGS. 7b and 7c are graphs from which the influences on the WDM optical transmission system due to the FWM are found. As mentioned above, the FWM means that optical signals with different wavelengths are mixed with each other to generate a new interference signal, which acts as crosstalk in the WDM optical transmission system. Consequently, the FWM is an important factor deteriorating the performance of the signal. The FWM is severely generated at the middle channels or the channels at which the dispersion value of the optical fiber are the smallest when several channels are transmitted. However, it is not possible to detect the FWM when the channels are within the wavelength band of the transmission system. In this case, the transmission is carried out while the channels are removed from the transmitting unit so that the FWM components at the band can be found. FIG. 7b shows the result of measuring the FWM under the condition that the middle channels, i.e., the eighth and ninth channels are removed, and FIG. 7c shows the result of measuring the FWM under the condition that the channels at which the dispersion value of the optical fiber are the smallest, i.e., the fifteenth and sixteenth channels are removed.

It can be seen from FIGS. 7b and 7c that no FWM components are detected in the optical network of the present invention, whereby the performance of the optical signal is not deteriorated.

As apparent from the above description, the present invention provides a wavelength-division-multiplexed metro optical network which is capable of adopting a direct modulation system and using an optical fiber having an appropriately adjusted negative dispersion value, thereby decreasing distortion of an optical signal, preventing an error, performing a long-distance transmission of the signal over 300 km without performance deterioration due to four-wave mixing.

Furthermore, the present invention also provides an economic metro optical network with a simple structure.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wavelength-division-multiplexed metro optical network comprising:
a transmitting unit having transmitters for directly modulating a light into digital optical signals with different wavelengths and outputting the modulated optical signals and a multiplexer for multiplexing the optical signals outputted from the transmitters and transmitting the multiplexed signal;
a receiving unit having a demultiplexer for receiving the multiplexed signal outputted from the multiplexer, demultiplexing the received signal on the basis of the respective wavelengths, and outputting the demutiplexed signals, and receivers for receiving the demutiplexed signals outputted from the demultiplexer; and
an optical fiber connected between the multiplexer and the demultiplexer, wherein the optical fiber has a negative dispersion value of from −1 ps/nm/km to −3.3 ps/nm/km at a wavelength of 1550 nm, and a positive dispersion inclination.

2. The network as set forth in claim 1, further comprising at least one optical amplifier disposed between the multiplexer and the demultiplexer.

3. The network as set forth in claim 2, wherein the distance between an optical amplifier and the neighboring optical amplifier is from 10 km to 80 km.

4. The network as set forth in claim 1, wherein the optical fiber has a zero-dispersion wavelength of from 1560 nm to 1595 nm.

5. The network as set forth in claim 1, wherein the transmitters have a transmission speed per channel of 10 Gb/s.
